(19) United States
(12) Patent Application Publication
(10) Pub. No.: US 2018/0091756 A1
(43) Pub. Date: Mar. 29, 2018

(54) REMOTE CONTROLLER, DRAWING METHOD AND DRAWING SYSTEM

(71) Applicant: BOE TECHNOLOGY GROUP CO., LTD., Beijing (CN)

(72) Inventors: Huiyuan TAN, Beijing (CN); Jian YU, Beijing (CN)

(21) Appl. No.: 15/539,754

(22) PCT Filed: May 20, 2016
(86) PCT No.: PCT/CN2016/082812

§ 371 Date: Jun. 26, 2017

(30) Foreign Application Priority Data
Mar. 3, 2016 (CN) 201610120097.9

(51) Int. Cl. H04N 5/44

(52) U.S. Cl. CPC H04N 5/4403; G08C 17/02

(57) ABSTRACT

A remote controller, a method for drawing on a TV using the remote controller and a drawing system are disclosed. The remote controller includes a touch panel and a detector that detects operations on the touch panel. The touch panel receives drawing operation inputs from a user. The present disclosure provides a touch panel for the remote controller to achieve drawing operation, thereby realizing large-screen drawing operation on a TV, meeting the demand for large-area drawing at home, enhancing functionality for the TV and improving user experience.

### CROSS-REFERENCE TO RELATED APPLICATIONS

The present application is the U.S. national phase entry of PCT/CN2016/082812, with an international filling date of May 20, 2016, which claims the benefit of Chinese Patent Application No. 201610120097.9, filed on Mar. 3, 2016, the entire disclosure of which is incorporated herein by reference.

### TECHNICAL FIELD

The present disclosure relates to the field of electric appliances, in particular to a remote controller, a method for drawing on a TV (television) using the remote controller and a drawing system.

### BACKGROUND

With the rapid development of smart TV technology, smart TVs are endowed with more and more functions, and more and more users enjoy the entertainment and convenience provided by smart TVs, including multimedia playing, file browsing, etc. Smart applications are becoming more and more popular and diversified in forms, and it is not difficult to develop a piece of drawing software running on a smart TV system.

Many non-professionals who are interested in art and drawing and parents having young children hope to have an area where they or their children can create freely, but owing to the limitations of house space, it is difficult to have a very large space for free creation. Thus smart TVs having a drawing function appeared. However, large touch screens are expensive and hard to manufacture at present, and they can hardly be afforded by common families, so it is difficult to popularize the way of providing input to the drawing software through touching the screens.

### SUMMARY

In view of this, the present disclosure proposes a remote controller, a method for drawing on a TV using the remote controller and a drawing system.

According to an aspect of the present disclosure, a remote controller is provided, comprising a touch panel and a detector configured to detect operations on the touch panel. The touch panel is configured to receive drawing operation inputs from a user. This solution innovatively provides a touch panel for the remote controller to achieve drawing operation, thereby realizing large-screen drawing operation on a TV, meeting the demand for large-area drawing at home, enhancing functionality of the TV and improving user experience. In addition, by means of this inventive remote controller, reformation of existing TVs can be easily realized so as to enable the drawing application.

In certain exemplary embodiments, the touch panel comprises a touch sensitive layer and a protective layer, as well as a pressure sensor below the touch sensitive layer. The pressure sensor can be used for sensing an intensity of pressure from a user so as to adaptively process according to the intensity.

In certain exemplary embodiments, the touch panel comprises a plurality of pressure sensors which are uniformly distributed below the touch sensitive layer. By providing multiple pressure sensors, pressure detection accuracy of the touch panel can be increased, thereby improving user experience and increasing resolution of the touch panel.

In certain exemplary embodiments, the remote controller comprises a switch button for activating the touch panel. Providing a switch button dedicated to the touch panel can prevent users' mis-operation to the touch panel under the TV remote controller mode and can help to increase lifetime of the touch panel.

In certain exemplary embodiments, the remote controller is a remote controller for TV, and the remote controller has a button for enabling the remote controller to send an instruction for running or stopping a drawing software to the TV. In this way, it is possible for the user to run the drawing software on the TV by one-click, which make the operation more convenient.

In certain exemplary embodiments, the remote controller comprises a top cover and a main body, the touch panel is arranged on the main body of the remote controller, and the top cover covers the touch panel when it is in a closed state. In this case, the touch panel can be protected in the TV remote controller mode, and the area of the touch panel can be increased to realize a better operation experience.

Further, the remote controller is a remote controller for TV, and the remote controller sends an instruction for running a drawing software to the TV in response to opening of the top cover, and sends an instruction for stopping the drawing software to the TV in response to closing of the top cover.

In certain exemplary embodiments, the remote controller activates the touch panel in response to opening of the top cover. In this way, the remote controller can intelligently activate the touch panel according to the user's wish of performing drawing operations, which may further improve user experience.

Further, the remote controller comprises a button for a drawing function, which is arranged on a surface of the top cover facing the main body, and further comprises buttons for common functions of the TV, which are arranged on a surface of the top cover facing away from the main body or in an area of the main body which is incapable of being covered by the top cover. Hence, the button for common function and the button dedicated for drawing operation are separated so as to increase convenience of user's operation.

In certain exemplary embodiments, upon detection of a double-click by the user on the touch panel, the touch input is interpreted as a start of drawing. This can enable a switching between a drawing mode and a mouse mode, thereby improving user experience.

In certain exemplary embodiments, when the pressure sensor senses a pressure from the user that is greater than a preset threshold, the touch input is interpreted as a start of drawing. This can enable a switching between a drawing mode and a mouse mode, thereby greatly improving user's operations on the TV.

In certain exemplary embodiments, thickness of a paintbrush is adjusted according to an intensity of the pressure from the user sensed by the pressure sensor. This can further improve user experience.

In certain exemplary embodiments, the remote controller further comprises a button for control function and a transmitter for transmitting control instructions, the transmitter being implemented by means of one selected from a group consisting of infrared, radio frequency of 2.4G or 5G, and Bluetooth. In an embodiment, the transmitter is implemented using the 2.4G or 5G wireless transmission technology so as to realize faster and more stable transmission speed.

According to another aspect of the present disclosure, a method for drawing on a TV using a remote controller is provided, comprising receiving drawing operation inputs from a user by a touch panel of the remote controller, detecting the drawing operation inputs of the user on the touch panel by a detector of the remote controller, and performing drawing operations on a display interface of the TV according to drawing operation inputs of the user.

This solution of the present disclosure innovatively realizes providing drawing operation inputs to the TV by means of the remote controller, thus making it possible to realize large-screen drawing operation on a TV, meeting the demand for large-area drawing at home, enhancing functionality of the TV and improving user experience.

In certain exemplary embodiments, the display interface of the TV includes a menu area in which menu items are arranged, a drawing area for drawing, a shortcut operation area and a state display area, and wherein a corresponding operation is capable of being performed in each of the areas by the user by means of the touch panel.

In certain exemplary embodiments, the method further includes activating the touch panel in response to turning-on of a switch for the touch panel or opening of a top cover of the remote controller.

In certain exemplary embodiments, the shortcut operation area includes a control area for setting at least one selected from a group consisting of paintbrush color, filling color, paintbrush thickness, graph shape and eraser.

According to still another aspect of the present disclosure, a drawing system is provided, which comprises a TV and the remote controller as described above. The TV presents an interface of a drawing software on a display screen thereof upon receiving an instruction for running the drawing software from the remote controller, and closes the interface of the drawing software upon receiving an instruction for stopping the drawing software from the remote controller.

The system of the present disclosure innovatively achieve providing drawing operation input to the TV by means of the remote controller, thus making it possible to realize large-screen drawing operation on the TV, meeting the demand for large-area drawing at home, enhancing entertainment and convenience of the TV and improving user experience.

### BRIEF DESCRIPTION OF THE DRAWINGS

The drawings are shown to provide further understanding to the embodiments and are incorporated into this specification to form a part thereof. The drawings illustrate the embodiments and explain the principles of the embodiments together with the descriptions. Other embodiments and many expectable advantages of the embodiments will be readily recognized, because they will become better appreciated by referring to the following detailed descriptions. Elements shown in the drawings are not necessarily in proportion. Like reference numerals indicate corresponding similar components.

FIG. 1 is a plan view of a remote controller for TV according to an embodiment of the present disclosure;

FIG. 2 is a plan view of a remote controller for TV according to another embodiment of the present disclosure;

FIG. 3 is a plan view of the remote controller shown in FIG. 2 with its top cover opened;

FIG. 4A is a structural diagram of layers of the touch panel in the remote controller according to an embodiment of the present disclosure;

FIG. 4B is a schematic view of arrangement of the pressure sensor according to an embodiment of the present disclosure in the touch panel;

FIG. 5 is a schematic functional block diagram of the remote controller according to an embodiment of the present disclosure;

FIG. 6 is a schematic view of an operating method for the remote controller according to an embodiment of the present disclosure; and

FIG. 7 is a schematic view of a display interface of the drawing software on the TV according to an embodiment of the present disclosure.

### DETAILED DESCRIPTION OF EMBODIMENTS

In the detailed descriptions below, reference is made to the drawings, which form a part of the detailed descriptions and which are shown as example embodiments in which the present disclosure can be carried out. Terms relating to direction, such as “top”, “bottom”, “left”, “right”, “on” and “below”, etc., are used with reference to orientations of the depicted drawings. Since components in the embodiments can be positioned in several different orientations, the terms regarding directions are used for purpose of illustration in the drawings and these terms are not restrictive. It shall be understood that other embodiments can be achieved or logical variations can be made without departing from the scope of the invention. Therefore, the following detailed descriptions should not be construed as limiting and the scope of the invention is defined by the appended claims.

It shall be appreciated that features in the exemplary embodiments described herein can be combined with one another unless otherwise specified.

FIG. 1 is a plan view of a remote controller for TV according to an embodiment of the present disclosure. Referring to FIG. 1, the remote controller mainly includes a button area 1 and a touch area 2. The button area 1 includes buttons 11 for controlling various functions of the TV. The touch area 2 includes a touch panel 21 for receiving touch inputs, e.g. drawing inputs, from the user. In an embodiment, the touch area 2 also includes buttons 22 dedicated for drawing input. In an embodiment, the buttons dedicated for drawing input include a functional button for activating/deactivating the touch panel 21 and a functional button for adjusting parameters like sensitivity and resolution of the touch panel 21. It shall be understood that the layout of functional areas, the various sizes and the numbers of various buttons as shown in FIG. 1 are exemplary, while remote controllers having various other functional area layouts and arrangements for the buttons and touch panel also fall into the protection scope of the present invention. The body of the remote controller may further be provided with a transmitter for transmitting control instructions to the TV, a controller for controlling components of the remote controller, a detector configured to detect inputs at each of the buttons and the touch panel, and a battery for supplying power to respective components, although they are not shown in the drawings. The detector may be configured to identify the user's operations on the touch panel, such as click, press, slide, etc. The remote controller according to this embodiment can easily realize various operations to the TV. Meanwhile, it can facilitate the user to perform various drawing operations on the display interface of the TV by means of the remote controller in the drawing mode.

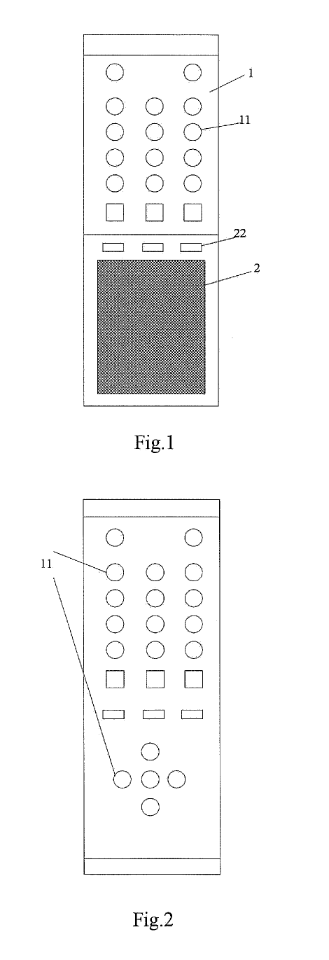

FIG. 2 is a plan view of a remote controller for TV according to another embodiment of the present disclosure. FIG. 2 shows a basic layout of the remote controller in an initial state. In this embodiment, the front surface of the remote controller includes various functional buttons, while the touch panel is not directly provided on the front surface of the remote controller. The touch panel is hidden under the top cover of the remote controller shown in FIG. 2.

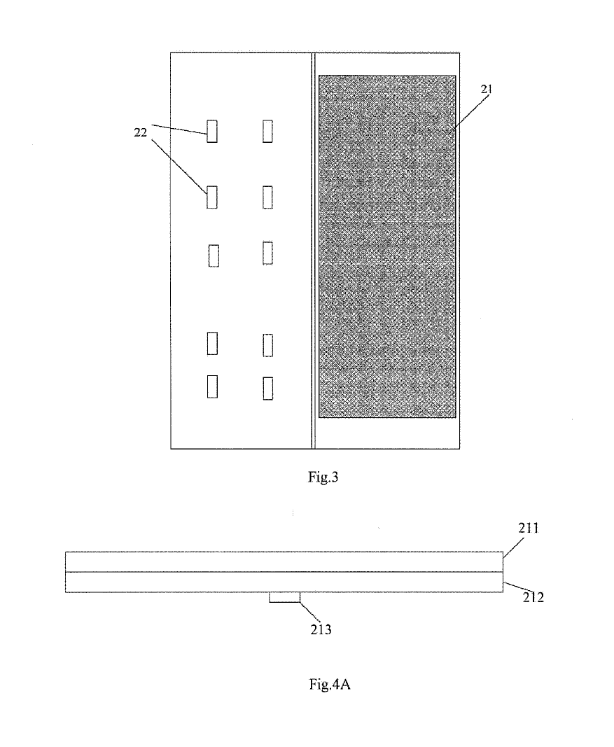

FIG. 3 is a plan view of the remote controller as shown in FIG. 2 with its top cover opened. It can be seen from FIG. 3 that the touch panel 21 is on the main body of the remote controller with its top cover opened. While on the back surface (shown in the left of FIG. 3) of the top cover, functional buttons 22 dedicated for drawing operations are arranged. Although not shown in the figure, buttons for common functions of the TV (including functions of channel switching, volume control, brightness control, contrast control, power on/off, etc. for the TV) can be arranged on a surface of the top cover facing away from the main body or on an area of the main body which will not be covered by the top cover. It shall also be appreciated that the layout and sizes of functional areas, and the numbers of various buttons as shown in FIGS. 2 and 3 are exemplary, while remote controllers having various other functional area layouts and arrangements for the buttons and touch panel also fall into the protection scope of the present invention.

The advantage of the remote controller in the embodiments shown in FIGS. 2 and 3 lies in that the touch panel can be hidden in case the user does not wish to perform drawing operations. In addition, the top cover can protect the touch panel. According to a preferred embodiment, the remote controller can automatically enter a drawing mode in response to opening of the top cover and enable corresponding drawing software to run in the TV.

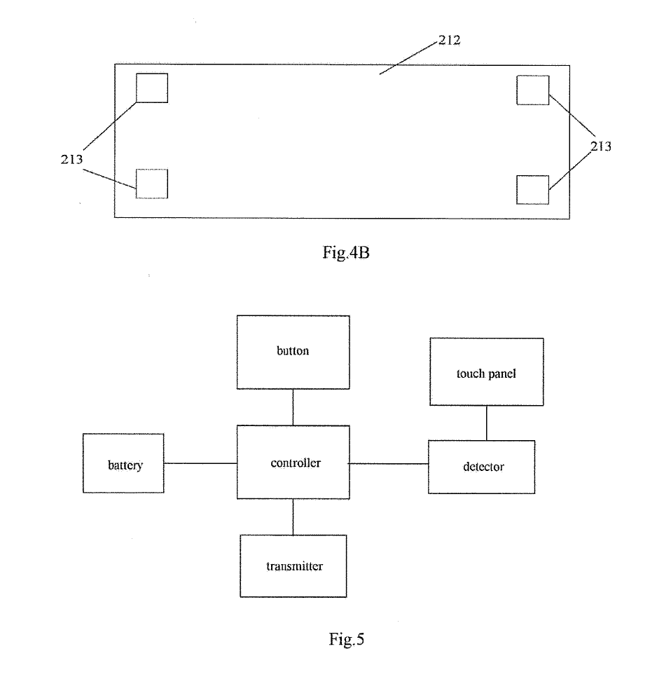

FIG. 4A is a structural diagram of layers of the touch panel in the remote controller according to an embodiment of the present disclosure. Referring to FIG. 4A, the touch panel 21 according to this embodiment mainly comprises a touch sensitive layer 212 and a protective layer 211. Optionally, the touch panel 21 may further comprise a pressure sensor 213 below the touch sensitive layer. In case of a plurality of pressure sensors 213, the plurality of pressure sensors 213 can be uniformly distributed below the touch sensitive layer so as to increase accuracy and sensitivity of pressure sensing. FIG. 4B shows an example bottom-up view of the touch panel 21, for which four pressure sensors 213 are provided below the touch sensitive layer 212. Specifically, the four pressure sensors 213 are arranged at the four corners of the touch sensitive layer. Of course, those skilled in the art shall appreciate that more than or less than four pressure sensors 213 may be arranged below the touch sensitive layer 212, and the arrangement positions of the pressure sensors are not limited to those shown in the figure. In addition, the structure of the touch sensitive layer 212 is known in the art, so it will not be elaborated herein any more.

FIG. 5 is a schematic functional block diagram of the remote controller according to an embodiment of the present disclosure. The remote controller mainly comprises a controller, buttons, a touch panel, a detector, a transmitter, a display module and the like. The touch panel comprises a touch sensitive layer and an optional pressure sensor, and the detector is configured to detect inputs at the touch panel. The transmitter is used for transmitting control instructions of the remote controller to the TV (not shown). In a preferred embodiment, the transmitter can be implemented by such wireless transmission technologies as infrared, radio frequency of 2.4G or 5G, or Bluetooth. The battery is used for supplying power to respective components of the remote controller.

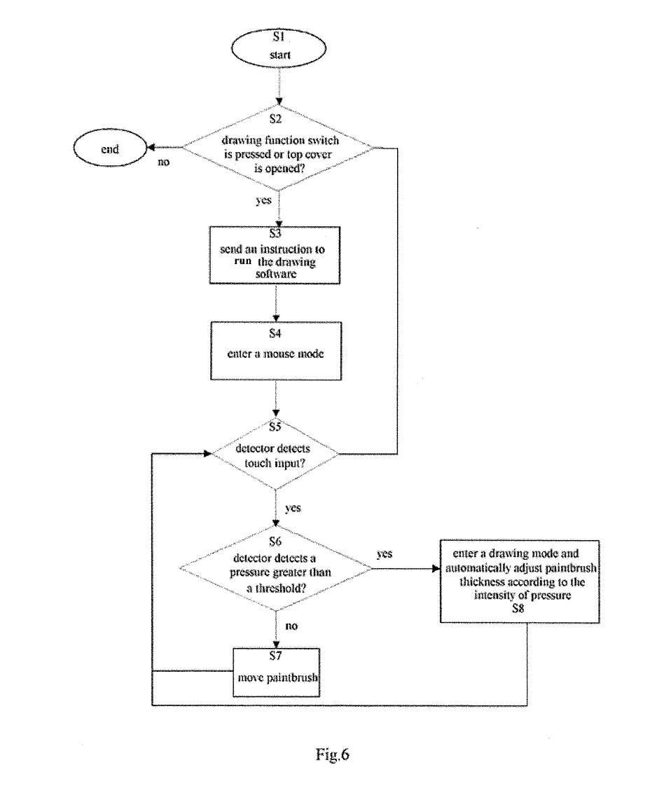

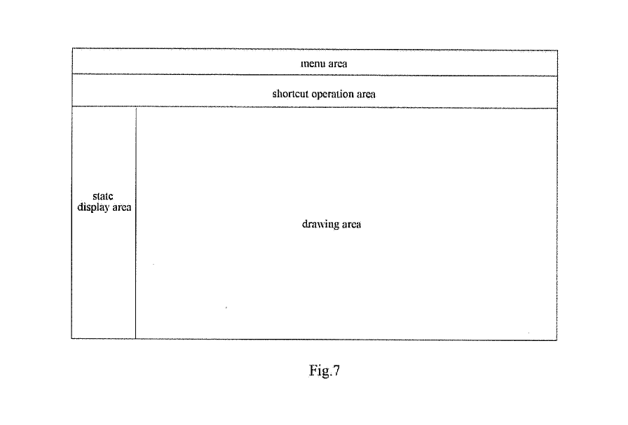

FIG. 6 is a schematic view of an operating method for the remote controller according to an embodiment of the present disclosure. Referring to FIG. 6, the method includes the following steps. At step S1, the method begins. At step S2, determining whether the drawing function switch on the remote controller is pressed or whether the top cover is opened, if no, the method ends, if yes, the method proceeds to step S3. At step S3, an instruction is sent by the remote controller to run the drawing software on the TV, then the method proceeds to step S4, in which a mouse mode is entered before proceeding to step S5. At step S5, determining whether a touch input is detected by the detector, if yes, the method proceeds to step S6, if no, the method returns to step S2. At step S6, if the detector detects a pressure greater than a threshold, the method proceeds to step S8, otherwise, the method proceeds to step S7. At step S7, moving the paintbrush without drawing any lines on the display interface, at step S8, the drawing mode is stated, i.e. drawing lines on the display interface and automatically adjusting thickness of the paintbrush according to the intensity of pressure.

FIG. 7 is a schematic view of a display interface for the drawing software on the TV according to an embodiment of the present disclosure. Referring to FIG. 7, the display interface mainly includes a menu area, a shortcut operation area, a state display area, and a drawing area. The menu area includes such menu buttons as “new”, “browse”, “save” and “exit”, and the user can perform corresponding operations by moving the mouse to this area. The shortcut operation area includes options of the paintbrush mode, such as “eraser”, “pencil”, “brush”, “stamp”, etc., and may also include an area for selection of the paintbrush color, filling color and paintbrush thickness. The state display area may be arranged to display the mode and color of the current paintbrush as well as other necessary information. The drawing area occupies most of the display interface for the user to perform drawing operations thereon. It shall be understood that the display interface shown is only for explaining the principle of the present disclosure, but it does not limit the protection scope of the invention.

The above described are only specific embodiments of the disclosure, which do not intend to limit the scope of the invention. Any variation or substitution that is easily conceivable by those skilled in the art within the technical scope disclosed by the present disclosure shall fall into the scope of the invention. Thus the protection scope of the present invention is defined by the scope of the appended claims.

It shall be appreciated that in the description of the disclosure, the directional or positional relationship indicated by such terms as “on”, “under”, “inside” and “outside” are directional or positional relationship as shown in the drawings, and they are only intended to facilitate illustration of the embodiments of the present disclosure and simplify descriptions, rather than indicating or suggesting that the referred to device or element must have a particular direction and position or be constructed and operated in a specific direction and position, so they shall not be construed as limiting the invention. In addition, although the steps are given in a certain order in a method claim, the steps are not necessarily carried out in the given order. Conversely, they can be carried out in parallel or in an opposite order without departing from the spirit and idea of the invention. The word “include” or “comprise” does not exclude other elements or steps than those stated in the claims, and the indefinite article “a” or “an” preceding an element does not exclude a plurality. The mere fact that certain measures are recited in mutually different dependent claims does not indicate that a combination of these measures cannot be used to advantage. Any reference sign present in the claims shall not be construed as limiting the scope.

1. A remote controller comprising:
a touch panel that receives drawing operation inputs from a user, and
a detector that detects the drawing operations on the touch panel.

2. The remote controller according to claim 1, wherein the touch panel comprises a touch sensitive layer and a protective layer, as well as a pressure sensor below the touch sensitive layer.

3. The remote controller according to claim 2, wherein the touch panel comprises a plurality of pressure sensors uniformly distributed below the touch sensitive layer.

4. The remote controller according to claim 1, wherein the remote controller comprises a switch button for activating the touch panel.

5. The remote controller according to claim 1, wherein the remote controller is a remote controller for TV, and the remote controller has a button for enabling the remote controller to send an instruction for running or stopping a drawing software to the TV.

6. The remote controller according to claim 1, wherein the remote controller comprises a top cover and a main body, wherein the touch panel is arranged on the main body of the remote controller, and the top cover covers the touch panel when it is in a closed state.

7. The remote controller according to claim 6, wherein the remote controller is a remote controller for TV, and the remote controller sends an instruction for running a drawing software to the TV in response to opening of the top cover, and sends an instruction for stopping the drawing software to the TV in response to closing of the top cover.

8. The remote controller according to claim 6, wherein the remote controller activates the touch panel in response to opening of the top cover.

9. The remote controller according to claim 6, wherein the remote controller comprises a button for a drawing function, which is arranged on a surface of the top cover facing the main body, and further comprises buttons for common functions of the TV, which are arranged on a surface of the top cover facing away from the main body or in an area of the main body which is incapable of being covered by the top cover.

10. The remote controller according to claim 1, wherein, upon detection of a double-click by the user on the touch panel, the touch input is interpreted as a start of drawing.

11. The remote controller according to claim 2, wherein when the pressure sensor senses a pressure from the user that is greater than a preset threshold, the touch input is interpreted as a start of drawing.

12. The remote controller according to claim 2, wherein thickness of a paintbrush is adjusted according to an intensity of the pressure from the user sensed by the pressure sensor.

13. The remote controller according to claim 1, wherein the remote controller further comprises a button for control function and a transmitter for transmitting control instructions, the transmitter being implemented by means of one selected from a group consisting of infrared, radio frequency of 2.4G or 5G, and Bluetooth.

14. A method for drawing on a TV using a remote controller, comprising:
receiving drawing operation inputs from a user by a touch panel of the remote controller,
detecting the drawing operation inputs of the user on the touch panel by a detector of the remote controller, and
performing drawing operations on a display interface of the TV according to drawing operation inputs of the user.

15. The method according to claim 14, wherein the display interface of the TV includes a menu area in which menu items are arranged, a drawing area for drawing, a shortcut operation area and a state display area, and wherein a corresponding operation is capable of being performed in each of the areas by the user by means of the touch panel.

16. The method according to claim 14, wherein the method further includes activating the touch panel in response to turning-on of a switch for the touch panel or opening of a top cover of the remote controller.

17. The method according to claim 15, wherein the shortcut operation area includes a control area for setting at least one selected from a group consisting of paintbrush color, filling color, paintbrush thickness, graph shape and eraser.

18. A drawing system, comprising a TV and the remote controller according to claim 1, wherein the TV presents an interface of a drawing software on a display screen thereof upon receiving an instruction for running the drawing software from the remote controller, and closes the interface of the drawing software upon receiving an instruction for stopping the drawing software from the remote controller.

19. The remote controller according to claim 2, wherein the remote controller is a remote controller for TV, and the remote controller has a button for enabling the remote controller to send an instruction for running or stopping a drawing software to the TV.

20. The remote controller according to claim 2, wherein the remote controller comprises a top cover and a main body, wherein the touch panel is arranged on the main body of the remote controller, and the top cover covers the touch panel when it is in a closed state.
